(19) United States
(12) Patent Application Publication
(10) Pub. No.: US 2007/0101652 A1
(43) Pub. Date: May 10, 2007

(54) Friction Adjuster for Window Balance Carriers

(75) Inventor: Jeffrey Charles Robertson, Rochester, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 11/553,509

(22) Filed: Oct. 27, 2006

Related U.S. Application Data
(60) Provisional application No. 60/731,107, filed on Oct. 28, 2005.

(51) Int. Cl. E05D 15/22

(52) U.S. Cl. 49/181

(57) ABSTRACT

A carrier for a window sash having an actuatable friction adjuster. The friction adjuster has a carrier interface that interacts with a mating friction adjuster interface of the carrier such that the actuation of the friction adjuster by rotating it within an oblong slot in the carrier causes the carrier interface to interact with the friction adjuster interface and forces a rear portion of the friction adjuster into progressively increasing frictional contact with an adjacent portion of a window frame sash channel.

### REFERENCE TO RELATED APPLICATIONS

This application claims an invention which was disclosed in Provisional Application No. 60/731,107, filed Oct. 28, 2005, entitled “Friction Adjuster For Window Balance Carriers”. The benefit under 35 USC § 119(e) of the United States provisional application is hereby claimed, and the aforementioned application is hereby incorporated herein by reference.

### BACKGROUND OF THE INVENTION

1. Field of the Invention

The present invention pertains to the field of window balance carriers. More particularly, the invention pertains to a friction adjuster for such carriers.

2. Description of Related Art

Window balance carriers are a common part of many window designs. They travel in a carrier channel in the window frame and support a window sash for the window. Within the carrier channel they are connected to a balance for the window. And, in the case of pivoting window sashes, which can be pivoted out of the plane of the window frame for cleaning or other purposes, they are typically provided with locking mechanisms. These locking mechanisms usually include members that are forced tightly against the inner walls of the channel when the sash is pivoted out of the frame. This serves to create a frictional grip between the carrier and the channel preventing the carrier from moving against the upward pull of the window balance even after the window has been pivoted out of the frame and/or removed.

In the usual case, the carrier has a generally rectangular horizontal cross-section and fits snugly albeit slidingly within the rectangular horizontal cross-section of the frame channel. This enables the carrier to slide up and down in the channel without twisting, binding or otherwise moving out of proper alignment within the channel. However, carriers and channels do not always fit together perfectly. Sometimes carriers fit too loosely within the channel. This, among other things, can allow the aforesaid problems to arise and interfere with carrier/window operation. Thus, it would be advantageous to provide a solution to this problem.

### SUMMARY OF THE INVENTION

The carrier with friction adjuster of the invention includes, in its most basic embodiments, a carrier for a window sash, and an actuatable friction adjuster for the carrier. The friction adjuster includes a carrier interface which interacts with a mating friction adjuster interface of the carrier such that actuation of the friction adjuster causes the carrier interface to interact with the friction adjuster interface and forces a rear portion of the friction adjuster into greater frictional contact with a portion of a window frame channel. A manipulation interface is provided for use in actuating the friction adjuster using a screw driver or other simple tool.

In the preferred embodiments illustrated, the friction adjuster's carrier interface and the friction adjuster interface of the carrier use a system of mating helical gear steps such that upon the simple rotation of the friction adjuster via the manipulation interface, the friction adjuster is urged outward from the carrier to contact the window frame with increasing frictional force. Finally, the friction adjuster can ideally be molded as part of and connected to the carrier, and held in place by simple break-away connections so that it can be broken away from said connections for use when and if the carrier ever needs tightening in its frame channel.

### BRIEF DESCRIPTION OF THE DRAWING

FIG. 1A provides a perspective view of a friction adjuster of the invention in the process of being inserted into a carrier of the invention or, alternatively, after being removed from connection to the carrier. The carrier and friction adjuster are shown from the sash facing side.

FIG. 1B provides a more detailed perspective view of the friction adjuster of the invention.

FIG. 2 provides a perspective view of the friction adjuster of the invention as it is being lowered into position into the carrier of the invention or, alternatively, as it is being removed from connection to the carrier. The carrier and friction adjuster are shown from the sash facing side.

FIG. 3A provides a perspective view of the friction adjuster of the invention prior to being separated from the carrier of the invention. The carrier and friction adjuster are shown from the frame facing side.

FIG. 3B provides a plane view of the friction adjuster of the invention prior to being separated from the carrier of the invention. The carrier and friction adjuster are shown from the frame facing side.

FIG. 4 provides a perspective view of the friction adjuster of the invention in position in the carrier of the invention, prior to being rotated. The carrier and friction adjuster are shown from the sash facing side.

FIG. 5 provides a perspective view of the friction adjuster of the invention in position in the carrier of the invention, after being slightly rotated. The carrier and friction adjuster are shown from the sash facing side.

FIG. 6 provides a cross-sectional view of the carrier and friction adjuster of the invention positioned in a frame channel.

FIG. 7A provides a plane view of the friction adjuster of the invention in position in the carrier of the invention, with both being appropriately positioned in a frame channel. The friction adjuster has been rotated. The carrier and friction adjuster are shown from the sash facing side.

FIG. 7B provides a partial cut-away perspective view of the friction adjuster of the invention in position in the carrier of the invention, with both being appropriately positioned in a frame channel. The friction adjuster has been rotated.

FIG. 8A provides a perspective view of the friction adjuster of the invention in position in the carrier of the invention, after being rotated. The carrier and friction adjuster are shown from the frame facing side.

FIG. 8B provides a second perspective view of the friction adjuster of the invention in position in the carrier of the invention, after being rotated. The carrier and friction adjuster are shown from the frame facing side.

### DETAILED DESCRIPTION OF THE INVENTION

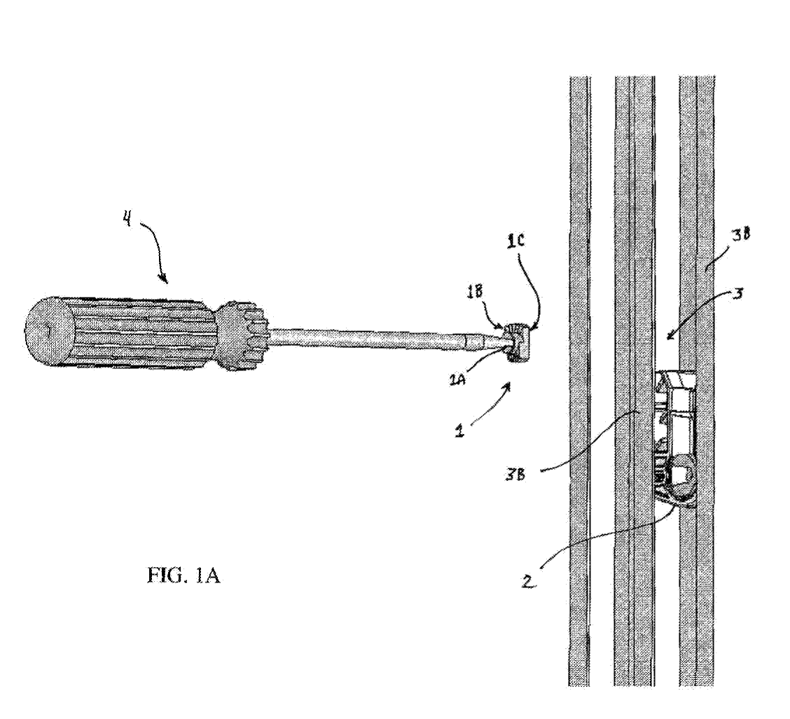

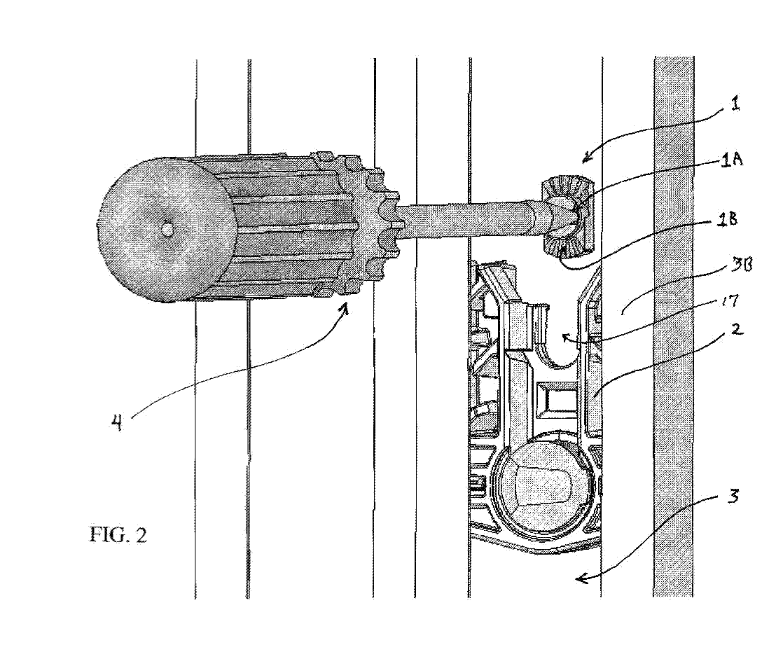

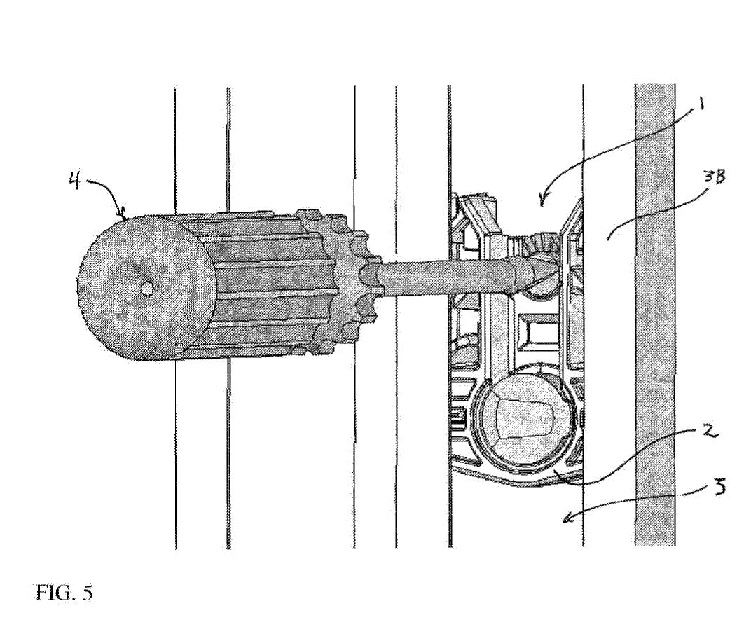

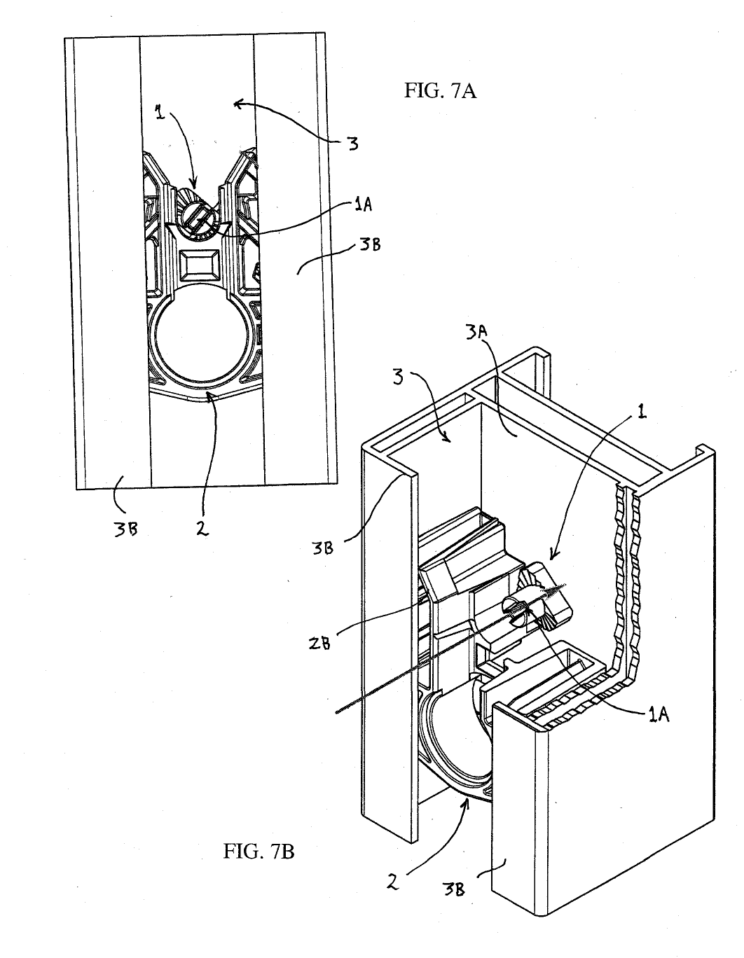

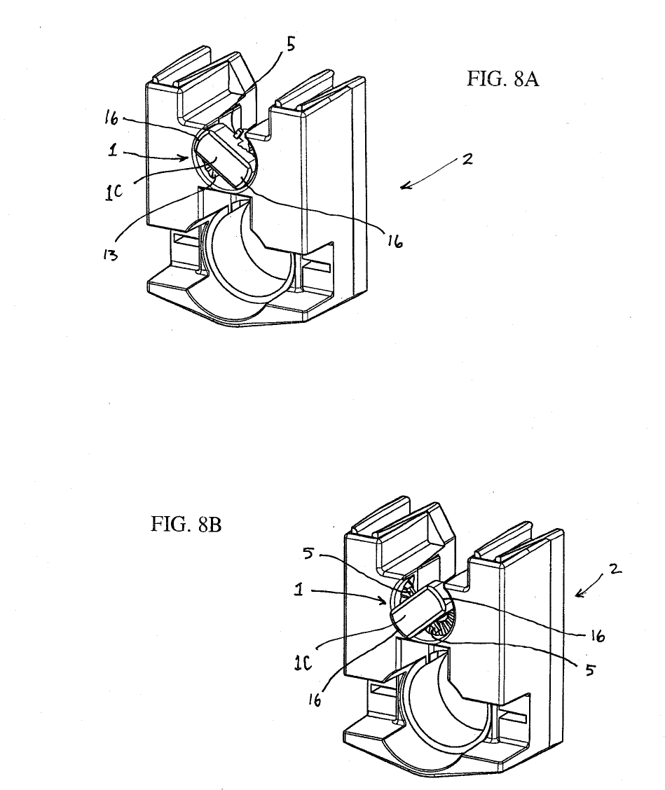

The friction adjuster of the present invention is characterized by the use of an actuatable friction adjuster 1 for a carrier 2 placed in a frame channel 3, as shown in FIG. 1A. The friction adjuster 1 includes a manipulation interface 1A and a carrier interface 1B. The manipulation interface 1A is on the same side of friction adjuster 1 as the carrier interface 1B and is used to manipulate the carrier interface 1B against a mating friction adjuster interface 2A of carrier 2 (refer to FIGS. 3A and 3B). As will be explored in more detail below, manipulation of the manipulation interface 1A causes the carrier interface 2A to interact with the friction adjuster interface 1B so as to force a rear portion 1C of the friction adjuster into varying degrees of frictional contact with a back portion 3A of the window frame channel 3 in which the carrier 2 is positioned (refer to FIGS. 6 and 7B).

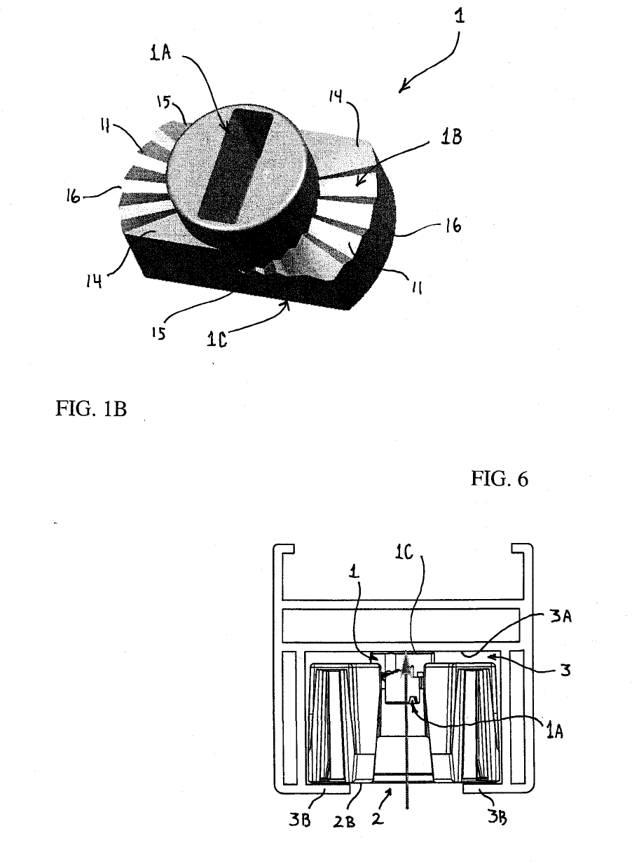

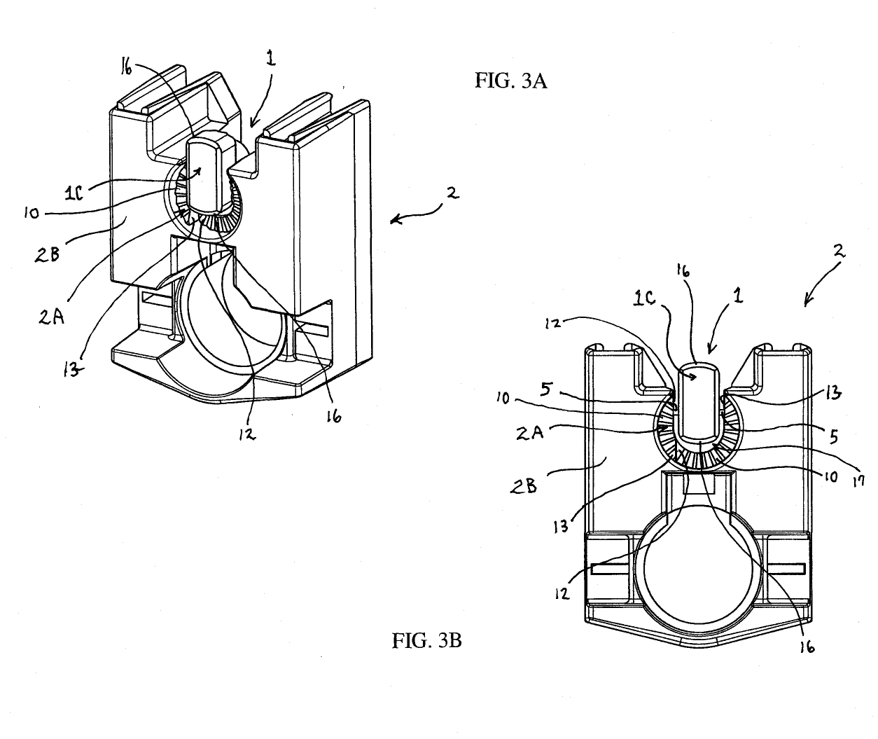

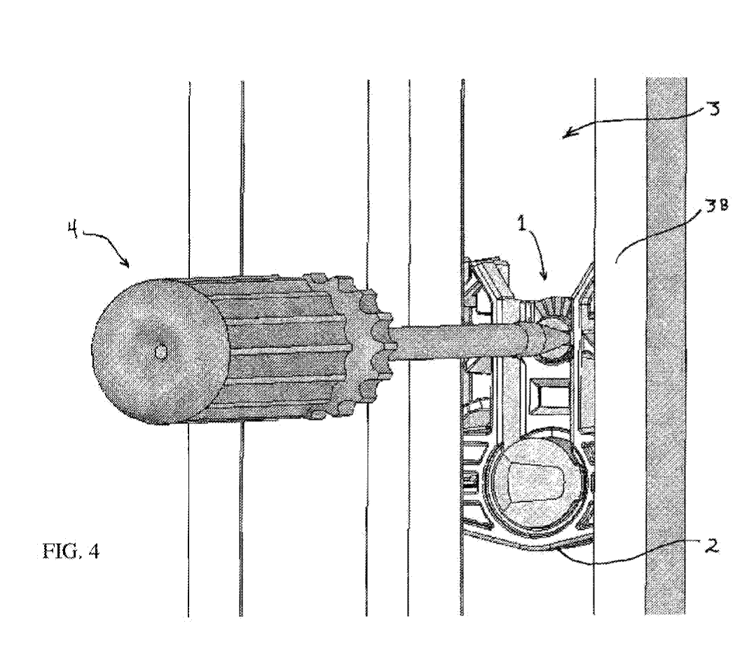

Ideally, manipulation interface 1A is adapted for use with a manipulation device, e.g. a common tool (such as a screwdriver 4), such that the friction adjuster 1 is actuated by rotation as shown in the drawing figures. Thus, as shown in the sequence illustrated in FIGS. 1A, 2, and 4, friction adjuster 1 (which is shown in greater detail in FIG. 1B) can be inserted into a carrier 2 positioned in the channel 3 of a window frame. It can then be rotated (as illustrated in FIG. 5) to varying degrees so as to bring rear portion 1C into greater or lesser contact with back portion 3A of frame channel 3. (refer to FIG. 6). This not only creates a closer contact between rear portion 1C and back portion 3A, it forces carrier front 2B into closer contact with the inside of frame channel 3 overhangs 3B (best shown in FIG. 7B).

The present invention relies on the interaction between sets of matched, interfacing helically stepped gear surfaces. The friction adjuster interface 2A of carrier 2 has two opposed sets of carrier helical steps 10, and the carrier interface 1B of friction adjuster 1 has two opposed sets of friction adjuster helical steps 11. As best seen in FIGS. 3A and 3B, the two sets of carrier helical steps 10 start at “low” points 12 and increase in “height” to “high” points 13, with the high point of each set of steps 10 being adjacent the low point of the other set. Likewise, as best seen in FIG. 1B, the two opposing sets of friction adjuster helical steps 11 start at “low” points 15 and increase in “height” to “high” points 14, with the high point of each set of steps 11 being adjacent to the low point of the other set. Thus, when the friction adjuster 1 is rotated so that low points 12 and 15 are adjacent, the friction adjuster 1 is only minimally engaged and minimally extends backwards towards back portion 3A. From this position it can be further turned through intermediate positions until it reaches a point where high points 13 and 14 are adjacent, and it is fully extended towards back portion 3A. In this manner, the present invention allows the effective size of carrier 2 to be adjusted as needed so that it better fits into frame channel 3. In addition, the matched stepped gear configuration allows interface 1 to retain the position to which it is adjusted.

The two sets of friction adjuster helical steps 11 are positioned on outwardly extending tabs 16 of friction adjuster 1 in keeping with its general oblong shape. This shape is advantageous as it allows the friction adjuster 1 to be mounted in and/or to freely slide into oblong slot 17 in carrier 2 without being engaged and to then be turned so as to engage and actuate the friction adjuster 1. In addition, it allows for easy molding of the friction adjuster 1 in oblong slot 17 (either above or adjacent its usual point of engagement) in a manner that allows it to be easily disconnected from the carrier 2 and used for its intended purpose. In keeping with this purpose, only light break-away connections 5 are provided between the friction adjuster 1 and the carrier 2 to facilitate its usage for the aforesaid purposes.

However, many variations are possible without exceeding the scope of the inventive concept described and patented herein. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A friction adjuster for window balance carriers, comprising:
a) a carrier for a window sash contained within a window sash frame channel;
b) an actuatable friction adjuster for the carrier;
c) wherein the friction adjuster includes a carrier interface, the carrier interface interacting with a mating friction adjuster interface of the carrier such that actuation of the friction adjuster causes the carrier interface to interact with the friction adjuster interface so as to force a portion of the friction adjuster into closer contact with a portion of a window frame channel.

2. The friction adjuster of claim 1 wherein the friction adjuster is not actuated by pivoting of the window sash.

3. The friction adjuster of claim 1, further comprising a manipulation interface for use in actuating said friction adjuster.

4. The friction adjuster of claim 3, wherein said manipulation interface is adapted for use with a manipulation device.

5. The friction adjuster of claim 1, wherein said carrier interface includes a helically stepped gear surface.

6. The friction adjuster of claim 1, wherein said friction adjuster interface includes a helically stepped gear surface.

7. The friction adjuster of claim 1, wherein the degree of frictional contact between the portion of the friction adjuster contacting the window frame channel and the window frame channel is adjustable.

8. The friction adjuster of claim 1, wherein a stepped gear configuration of at least one of the carrier interface and the friction adjuster interface allow the friction adjuster to maintain its position after actuation of the friction adjuster.

9. The friction adjuster of claim 1, wherein said friction adjuster is initially molded as part of and connected to said carrier and can be broken away from said connections when it is necessary to actuate the friction adjuster.

10. A carrier with friction adjuster, comprising:
a) a carrier for a window sash contained within a window sash channel;
b) an actuatable friction adjuster for the carrier having a manipulation interface for actuating said friction adjuster;
c) wherein the friction adjuster includes a carrier interface, the carrier interface interacting with a mating friction adjuster interface of the carrier such that actuation of the friction adjuster causes the carrier interface to interact with the friction adjuster interface so as to force a portion of the friction adjuster into adjustable frictional contact with a portion of a window frame channel; and
d) wherein the friction adjuster is not actuated by pivoting of the window sash such that the friction adjuster maintains its position after actuation.

11. The carrier with friction adjuster of claim 10 wherein the degree of contact between a portion of the friction adjuster contacting the window frame channel and the window frame channel is adjustable.

12. The carrier with friction adjuster of claim 10, wherein said manipulation interface is adapted for use with a manipulation device.

13. The carrier with friction adjuster of claim 10, wherein said carrier interface and the friction adjuster interface include interfacing helically stepped gear surfaces.

14. The carrier with friction adjuster of claim 10, wherein the stepped gear configuration of at least one of the carrier interface and the friction adjuster interface allow the friction adjuster to maintain its position after actuation.

15. The carrier with friction adjuster of claim 10, wherein said friction adjuster is initially molded as part of and connected to said carrier and can be broken away from said connections when it is necessary to actuate the friction adjuster.

16. A method for adjusting the frictional force between a carrier of a window sash and a sash channel of a window frame comprising the steps of:
a) installing an actuatable friction adjuster within the carrier, wherein the friction adjuster has a carrier interface that is engagable with a friction adjuster interface on the carrier, the friction adjuster having a rotatable manipulation interface for actuating the friction adjuster,
b) actuating the friction adjuster by use of a rotatable manipulation device on the manipulation interface to apply a desired amount of frictional force between the carrier and an adjacent portion of the sash channel.

17. The method of claim 16 wherein the carrier interface includes a plurality of helical steps on each side of the manipulation interface that engage with mating helical steps on the friction adjuster interface upon actuation of the friction adjuster by the manipulation device.

18. The method of claim 17 wherein with the continuing rotation of the manipulation device, the force between the friction adjuster interface of the carrier and the carrier interface of the friction adjuster progressively increases resulting in progressively increasing friction between the carrier and the sash channel.
